(19) United States
(12) Patent Application Publication
(10) Pub. No.: US 2008/0021171 A1
(43) Pub. Date: Jan. 24, 2008

(54) Storage Stable Polymer-Oligomer Particles And Their Use In Seed Polymerisation

(76) Inventors: Steinar Pedersen, Skien (NO); Kari-Anne Leth-Olsen, Skien (NO); Oystein Paulsen, Brevik (NO)

Correspondence Address: WENDEROTH, LIND & PONACK, L.L.P., 2033 K STREET N. W., SUITE 800, WASHINGTON, DC, 20006-1021, US

(21) Appl. No.: 10/593,478

(22) PCT Filed: Mar. 14, 2005
(86) PCT No.: PCT/NO05/00090

§ 371 Date: May 16, 2007

(30) Foreign Application Priority Data
Mar. 22, 2004 (NO) 20041205

(51) Int. Cl. C08F 2/18; C08C 19/20; C08F 291/00

(52) U.S. Cl. 525/343

(57) ABSTRACT

Storage stable polymer-oligomer particles with a high swelling capacity are produced by means of two-stage seed polymerisation in which the mole ratio between initiator and monomer is in the range from 0.07:1 to 0.01:1. These particles are used to produce polymer particles with a narrow size distribution by seed polymerisation.

The present invention concerns a procedure for producing storage stable, swellable polymer-oligomer particles that are used to produce polymer particles with a narrow size distribution via seed polymerisation.

Polymer particles today are used in several application areas such as separation, chromatography, adsorbents, ion exchangers, drug-delivery systems, solid-phase peptide synthesis, diagnostics and cosmetic preparations. Each area requires customized properties in the particles. The challenge is to control particle size, size distribution, polymer composition, porosity and functionality.

These applications are in continuous development and the need for particles that are uniform in terms of size, shape and functionality is growing. Uniform particles can be produced by classification of particles produced by conventional suspension polymerisation, but this is unsatisfactory as it is labour-intensive and produces a low yield of the particles required.

Therefore, relatively good processes have now been developed based on seed polymerisation. This method is based on uniform, relatively small particles being produced in a first stage and then being used as seed particles in one or more subsequent stages. Depending on how the seed particles are produced, they can absorb or being swelled from 0.5 to more than 1000 times their own volume with low-molecular compounds such as solvents and monomers. When monomer is incorporated in the seed particles and the monomer is subsequently polymerised, the process is called seed polymerisation. U.S. Pat. No. 5,130,343 and the literature to which reference is made in it provides a comprehensive description of prior art.

However, there are several weaknesses in the processes described. This is particularly true when relatively large polymer particles are to be produced, i.e. in the range 10 to 100 micrometers. When seed particles are swelled, their size increases proportionally to the cube root of the increase in volume. A swelling of 1000 times thus produces an increase in diameter of just 10 times. There is therefore a need for both relatively large seed particles and very swellable seed particles.

NO 31056 proposes a solution in which seed particles are produced by dispersion polymerisation. A homogeneous solution of monomer in a polar organic solvent containing initiator is subjected to polymerisation so that polymer particles are precipitated out of the solution and grow in controlled manner into free, relatively large particles. This method can produce uniform particles up to 10 micrometers in size. The particles can be swelled more than 100 times with monomer or solvent. The major known disadvantage of this technique is the use of organic solvent as the reaction medium. This requires that the particles are separated and transferred to an aqueous dispersion for use in the subsequent seed polymerisation. It is also difficult to produce cross-linked particles with this method, which prevents the synthesis of homogeneously cross-linked particles with a uniform nature. It is also known that the range of monomers that can easily be used in large-scale processes is limited.

In U.S. Pat. No. 5,147,937, small seed particles produced by conventional emulsion polymerisation are used. Emulsion polymerisation takes place in an aqueous medium, and the particles are created in the aqueous phase and stabilised by an emulsifier. The emulsifier also ensures that the monomer is kept emulsified in the aqueous phase as relatively large drops. These drops function as a reservoir for the monomer during the process. This method makes it possible to produce uniform particles up to approximately 1 micrometer in size. However, high-molecular weight polymer is always created in emulsion polymerisation. This greatly restricts the particles' swelling capacity, and normally it is never possible to swell a high-molecular weight polymer more than 2 to 5 times. The problem is avoided here by eliminating the need to swell the seed particles much. Instead, a controlled quantity of monomer is added to the seed particles while polymerisation takes place. The quantity of free monomer never exceeds 10% of the polymer particle weight present. By polymerising in many repeated stages, the required particle diameter can finally be achieved. Production of particles in the range 1 to 50 micrometers is specified. The major disadvantage of this method is that the original seed particle is small and it is demanding and relatively inefficient to have such limited swelling of the seed particles. In principle, this leads to many repeated stages before large particles can be achieved.

U.S. Pat. No. 4,530,956 announces a pioneering principle called the “Ugelstad process”, after the inventor, or the “two-stage swelling method”, which indicates the special feature of the process. The original seed particles are produced by standard emulsion polymerisation here as well. The seed particles are made very swellable by incorporating a water-insoluble, low-molecular weight compound in a first stage. This may either be an oligomer or an organic compound. In stage two of the process, the monomer is then swelled in under conditions where the oligomer or the organic compound cannot leave the seed particles. The only possible transport is of the monomer into the seed particles. Polymerisation is carried out when the swelling has been completed. The presence of oligomer or a low-molecular compound has an enormous effect on the swelling capacity, and other prior art measures such as the reduction of interfacial tension, use of solvating solvent or a slightly water-soluble organic solvent to facilitate the diffusion of monomer from the aqueous phase into the seed particles have very little effect by comparison.

The documents to which reference is made describe which common monomers, initiators and stabilisers can be used.

The oligomer in accordance with U.S. Pat. No. 4,530,956 has a degree of polymerisation between 5 and 200, or an equivalent molecular weight between 500 and 20,000 Dalton. The monomer added in stage two has a water solubility that is more than 10 times higher than that of the oligomer, and the volume ratio between the monomer and the seed particles is greater than 20. It is claimed that it is advantageous to control the molecular weight of the oligomer created by adjusting the ratio between the initiator and the monomer. The molecular weights specified will normally require a mole ratio between monomer and initiator of from 0.25:1 to 50:1.

To create seed particles that consist of oligomer, monomer and initiator can be swelled in at the same time or in two stages. It is possible to build on the oligomer seed particles in new stages until the desired final diameter has been achieved. Therefore, it is possible to produce seed particles of virtually any size.

The advantage of this method is that it is possible to swell in a huge amount of monomer in stage two. This means both that a large increase in diameter can be achieved, if required, and that it is easy to customise particles by introducing mixtures of monomers and solvents. The nature of the process is such that a large range of substances can be used, and gives a great degree of freedom in the synthesis of polymer particles.

WO 00/616447 contains proposals for an optimised process of the same type as that described in U.S. pat. No. 4,530,956. When oligomer seed particles are used, the molecular weight of the oligomer is under 5000 Dalton or the degree of polymerisation is below 50.

However, here too, there are disadvantages that limit the use of the process in industrial contexts. When seed particles mainly consist of low-molecular compounds or oligomers, they are very soft and not very rigid compared to a particle that consists of high-polymer compounds. This leads to problems both during the synthesis of the seed particles and during their storage. Soft particles are often also sticky, and this combination easily leads to coalescence. The result of this will often be a broader particle size distribution, creation of aggregates and large particles as well as fouling in the reactor and storage tank. The production of polymer particles based on a large reservoir of seed particles cannot therefore be expected. This leads to a need for frequent production of small volumes of both seed particles and polymer particles. This is a major disadvantage in terms of repeatability from batch to batch and has a generally large effect on the productivity and cost of the process.

The storage stability will be rated good if the particles can be used with good results even after more than one month's storage. This makes it possible to produce a small number of large batches for a given production volume of the polymer particles required. This is good economically and produces the best results with regard to the reproducibility of the polymer particles.

High swelling capacity has been achieved when the seed particles account for less than 5 percent by weight of the polymer particles. This means a degree of swelling of more than 20 times the inherent seed particle volume by a monomer or a mixture containing a monomer. A high swelling capacity means both that the seed particles have a smaller effect on the polymer particles' properties after polymerisation has ended and that the seed particles account for a lower proportion of the total costs of production of the final polymer particles.

The particle size distribution is called narrow when the coefficient of variation (CV), defined as the standard deviation (SD) divided by the mean particle size (dp) multiplied by 100 (CV=SD/dp*100%), is less than 35%, preferably less than 20%.

The present invention attempts to remedy the disadvantages of existing processes stated above. The aim of the invention is to produce storage stable, relatively large seed particles that also have a very high swelling capacity. This will also create the basis for advantageous production of large polymer particles with a narrow size distribution for the applications stated above by means of simple, easily controllable seed polymerisation.

Surprisingly, it has been found that it is possible to produce polymer-oligomer particles that have both good storage stability and adequate swelling capacity to be used as seed particles for the production of large uniform polymer particles. These and other aspects of the present invention will now be described in further detail.

The starting point for the polymer-oligomer seed particles is the production of small polymer particles by means of standard emulsion polymerisation. This is a widely known technique. See, for example, “Die Angewandte Makromolekulare Chemie, 195, (1992), 151-164 (Nr. 3373)”. In many cases, it is advantageous to utilise this stage of production to achieve the largest possible particles. Normally, the maximum particle size in standard emulsion polymerisation will be around 1 micrometer.

Polymer-oligomer seed particles are then produced from these particles. The degree of polymerisation and thus the molecular weight of the polymer-oligomer is controlled via the ratio between the initiator and monomer used. More precisely, it is the speed with which radicals are created in relation to the speed with which polymer-oligomer is created from growing radicals that determines the degree of polymerisation. As it is essential to avoid having too large a fraction of very short oligomer chains, it is usually necessary to use a mole ratio between initiator and monomer that is from 0.07:1 to 0.01:1, preferably between 0.06:1 and 0.03:1. It is advantageous that in a first stage, the initiator is swelled into the polymer particles made by the emulsion polymerisation. As these consist of high-molecular weight polymer, it is difficult to swell in more than 5 times their volume with initiator. To facilitate the swelling as much as possible, the initiator may be added as a finely divided aqueous emulsion. It may help still further to add a solvent for the initiator that can also be mixed with water. This increases the diffusion of initiator through the aqueous phase. When the initiator has been completely swelled in, the monomer or a mixture containing the monomer can relatively easily be swelled into the particles. The monomer or the mixture containing a monomer can be added as a finely divided aqueous emulsion, it can be added dropwise or directly to the seed solution. It is preferable to add the monomer dropwise. After the polymerisation has been completed, the polymer-oligomer seed particles required are created. By repeating the process, polymer-oligomer seed particles of the sizes required can be produced.

A procedure for the production of storage stable polymer-oligomer particles with a high swelling capacity, i.e. they can absorb from 20 to 300 times their own volume of an oil-soluble compound, is characterised in that the polymerisation is carried out as two-stage seed polymerisation in which the mole ratio between initiator and monomer is in the range from 0.07:1 to 0.01:1.

The final seed polymerisation can then relatively easily be carried out in accordance with the prior art by swelling monomer or a mixture containing monomer into the polymer-oligomer seed particles produced in advance and carrying out polymerisation. The size and properties of the final particles can easily be controlled by the swelling ratio selected and the composition selected for the monomer mixture. The monomer mixture may consist of various types of monomer, inert solvent and polymerisation initiator. Macroporous particles can be produced if favourable mixtures of cross-linking agents, monomers and inert solvents are selected. This is a technique familiar to an expert in the field.

The present invention will now be described in further detail in the examples given below. The results concerning swelling and storage stability are summarised in Table 1.

### EXAMPLE 1

### Production of Polystyrene Seed by Emulsion Polymerisation

Deionised water (2700 g), Nacl (2.29 g), potassium persulphate (1.76 g) and styrene (267 g) were mixed and added to a 5-litre double-walled glass reactor. Oxygen was removed from the solution by bubbling nitrogen through it. The temperature was increased to 75° C. and the agitation speed was set to 200 RPM. The polymerisation was allowed to take place over night. Polystyrene particles with a diameter of 0.82 μm and a narrow size distribution were achieved.

### EXAMPLE 2

### Production of Polystyrene Seed by Emulsion Polymerisation

Deionised water (2700 g), NaCl (2.29 g), Aerosol MA (0.40 g), potassium persulphate (1.76 g) and styrene (267 g) were added to a 5-litre double-walled steel autoclave. Oxygen was removed by repeated pressurisation of the reactor with nitrogen with intermediate evacuation. The temperature was increased to 75° C. and the agitation speed was set to 400 RPM. The polymerisation was allowed to take place over night. Polystyrene particles with a diameter of 1.2 μm and a narrow size distribution were achieved.

### EXAMPLE 3

### Production of Styrene-Based Polymer-Oligomer Seed (1.7 μm)

Deionised water (720 g), sodium lauryl sulphate (NaLS, 4.3 g)(emulsifier), dioctanoyl peroxide (Perkadox SE-8, 40.0 g)(initiator) and acetone (133 g) were emulsified using an ultrasonic probe for 10 minutes. Polystyrene seed produced according to Example 1 (48.0 g seed, 578 g latex) was added to the emulsion together with NaLS (0.8 g) and acetone (29.6 g). The mixture was transferred to a flask, which was left to agitate at approximately 25° C. for approximately 48 hours. Acetone was then removed and the solution was added to a 5-litre double-walled glass reactor. The temperature was increased to 40° C. while styrene (336 g) and divinyl benzene (DVB80, 0.88 g)(cross-linking agent) were added dropwise over approximately 60 minutes. After 4 hours from the start of adding styrene and DVB, deionised water (1200 g), potassium iodide (KI, 1.28 g) and polyvinyl pyrrolidone (PVP K-30, 18.48 g) were added and the temperature was increased to 70° C. The polymerisation was allowed to take place for 6 hours at 70° C. and 1 hour at 90° C. Styrene-based oligomer particles with a diameter of 1.7 μm and a narrow size distribution were achieved.

### EXAMPLE 4

### Production of Styrene-Based Polymer-Oligomer Seed (3.5 μm)

Deionised water (720 g), NaLS (4.3 g), Perkadox SE-8 (40.0 g) and acetone (133 g) were emulsified using an ultrasonic probe for 10 minutes. Styrene-based polymer-oligomer seed produced according to Example 3 (48.0 g seed, 331 g latex) was added to the emulsion together with NaLS (0.33 g) and acetone (34.8 g). The mixture was transferred to a flask, which was left to agitate at approximately 25° C. for approximately 48 hours. Acetone was then removed and the solution was added to a 5-litre double-walled glass reactor. The temperature was increased to 40° C. while styrene (336 g) and DVB80 (0.88 g) were added dropwise over approximately 60 minutes. After 4 hours from the start of adding styrene and DVB80, deionised water (1200 g), KI (1.28 g) and PVP K-30 (18.48 g) were added and the temperature was increased to 70° C. The polymerisation was allowed to take place for 6 hours at 70° C. and 1 hour at 90° C. Styrene-based oligomer particles with a diameter of 3.5 μm and a narrow size distribution were achieved.

### EXAMPLE 5

### Production of Styrene-Based Polymer-Oligomer Seed (2.3 μm)

Deionised water (720 g), NaLS (4.3 g), Perkadox SE-8 (40.0 g) and acetone (133 g) were emulsified using an ultrasonic probe for 10 minutes. Polystyrene seed produced according to Example 1 (16.0 g seed, 193 g latex) was added to the emulsion. The mixture was transferred to a flask, which was left to agitate at approximately 25° C. for approximately 48 hours. Acetone was then removed and the solution was added to a 5-litre double-walled glass reactor. The temperature was increased to 40° C. while styrene (336 g) and DVB80 (0.88 g) were added dropwise over approximately 60 minutes. After 4 hours from the start of adding styrene and DVB80, deionised water (1200 g), KI (1.28 g) and PVP K-30 (18.48 g) were added and the temperature was increased to 70° C. The polymerisation was allowed to take place for 6 hours at 70° C. and 1 hour at 90° C. Styrene-based oligomer particles with a diameter of 2.3 μm and a narrow size distribution were achieved.

### EXAMPLE 6

### Production of Styrene-Based Polymer-Oligomer Seed (5.2 μm)

Deionised water (720 g), NaLS (4.3 g), Perkadox SE-8 (40.0 g) and acetone (133 g) were emulsified using an ultrasonic probe for 10 minutes. Styrene-based polymer-oligomer seed produced according to Example 5 (29.0 g seed, 182 g latex) was added to the emulsion together with NaLS (2.5 g) and acetone (15.4 g). The mixture was transferred to a flask, which was left to agitate at approximately 25° C. for approximately 48 hours. Acetone was then removed and the solution was added to a 5-litre double-walled glass reactor. The temperature was increased to 40° C. while styrene (336 g) and DVB80 (0.88 g) were added dropwise over approximately 60 minutes. After 4 hours from the start of adding styrene and DVB80, deionised water (3600 g), KI (2.60 g) and PVP K-90 (37.5 g) were added and the temperature was increased to 70° C. The polymerisation was allowed to take place for 6 hours at 70° C. and 1 hour at 90° C. Styrene-based oligomer particles with a diameter of 5.2 ,m and a narrow size distribution were achieved.

### EXAMPLE 7

### Use of Styrene-Based Polymer-Oligomer Seed for the Production of Porous Particles

Deionised water (110 g), methyl hydroxypropyl cellulose (Methocel K-100, 0.22 g), NaLS (0.31 g), styrene (23.0 g), ethylene glycol dimethacrylate (EGDMA, 23.0 g), pentyl acetate (50.7 g) and azo bis methyl butyronitrile (AMBN, 0.16 g) were mixed and emulsified using an ultrasonic probe for 5 minutes. Styrene-based polymer-oligomer seed produced according to Example 6 (3.13 g seed, 38 g latex) was added to the emulsion. The mixture was transferred to a 0.5-litre double-walled glass reactor with agitators and the temperature was increased to 40° C. After 2.5 hours, deionised water (279 g), KI (0.04 g) and Methocel K-100 (1.89 g) were added to the reactor before the temperature was increased to 80° C. The polymerisation was allowed to take place over night. Porous poly(styrene-ko-EGDMA) particles with a diameter of 17 μm and a narrow size distribution were achieved.

### COMPARATIVE EXAMPLE 1

### Production of Oligomer Seed (2.2 μm)

Deionised water (90 g), NaLS (0.54 g), Perkadox SE-8 (4.55 g) and acetone (16.64 g) were emulsified using an ultrasonic probe for 10 minutes. Polystyrene seed produced according to Example 2 (2.0 g seed, 27.3 g latex) was added to the emulsion. The mixture was transferred to a flask, which was left to agitate at approximately 25° C. for approximately 48 hours. Acetone was then removed and the solution was added to a 0.5-litre double-walled glass reactor. The temperature was increased to 40° C. while styrene (19.21 g) and DVB80 (0.05 g) were added dropwise over approximately 60 minutes. After 4 hours from the start of adding styrene and DVB80, deionised water (400 g) and KI (0.16 g) were added and the temperature was increased to 70° C. The polymerisation was allowed to take place for 6 hours at 70° C. and 1 hour at 90° C. Styrene-based oligomer particles with a diameter of 2.2 μm and a narrow size distribution were achieved.

### COMPARATIVE EXAMPLE 2

### Production of Oligomer Seed (4.2 μm)

Deionised water (90 g), NaLS (0.54 g), Perkadox SE-8 (4.55 g) and acetone (16.64 g) were emulsified using an ultrasonic probe for 10 minutes. Styrene-based oligomer seed produced according to Comparative example 1 (4.0 g seed, 138 g latex) was added to the emulsion. The mixture was transferred to a flask, which was left to agitate at approximately 25° C. for approximately 48 hours. Acetone was then removed and the solution was added to a 0.5-litre double-walled glass reactor together with deionised water (100 g). The temperature was increased to 40° C. while styrene (19.21 g) and DVB80 (0.05 g) were added dropwise over approximately 60 minutes. After 4 hours from the start of adding styrene and DVB80, deionised water (400 g), KI (0.16 g) and PVP K-30 (2.31 g) were added and the temperature was increased to 70° C. The polymerisation was allowed to take place for 6 hours at 70° C. and 1 hour at 90° C. Styrene-based oligomer particles with a diameter of 4.2 μm and a narrow size distribution were achieved.

### COMPARATIVE EXAMPLE 3

### Production of Oligomer Seed (7.5 μm)

Deionised water (90 g), NaLS (0.54 g), Perkadox SE-8 (4.55 g) and acetone (16.64 g) were emulsified using an ultrasonic probe for 10 minutes. Styrene-based oligomer seed produced according to Comparative example 2 (5.0 g seed, 147 g latex) was added to the emulsion. The mixture was transferred to a flask, which was left to agitate at approximately 25° C. for approximately 48 hours. Acetone was then removed and the solution was added to a 0.5-litre double-walled glass reactor together with deionised water (100 g). The temperature was increased to 40° C. while styrene (19.21 g) and DVB80 (0.05 g) were added dropwise over approximately 60 minutes. After 4 hours from the start of adding styrene and DVB80, deionised water (400 g), KI (0.16 g) and PVP K-90 (2.31 g) were added and the temperature was increased to 70° C. The polymerisation was allowed to take place for 6 hours at 70° C. and 1 hour at 90° C. Styrene-based oligomer particles with a diameter of 7.5 μm and a narrow size distribution were achieved.

The swelling capacity was determined by making an emulsion of styrene in water using NaLS as the emulsifier. The styrene emulsion was added to seed particles in a volume ratio of styrene:seed=100:1. The diameter of the swelled particles in relation to that of the seed particles was determined using a light microscope.

The storage stability was determined by storing produced seed particles on a shaking machine under equal, very mild conditions. The coalescence of seed particles was determined by observing the seed particles daily in a light microscope. The results are shown in Table 1.

TABLE 1
Results concerning storage stability and swelling capacity

| | | Initiator/ | Degree of | Swelling | Storage |
|---|---|---|---|---|---|
| | Diameter | monomer | polymerisation | capacity | stability |
| | (μm) | (mole/mole) | (mon. units) | (volume) | (days) |
| Example 3 | 1.7 | 0.04 | 71 | >100 | >40 |
| Example 4 | 3.5 | 0.04 | 71 | >100 | >40 |
| Example 5 | 2.3 | 0.04 | 73 | >100 | >40 |
| Example 6 | 5.2 | 0.04 | 72 | >100 | >40 |
| Comparative | | | | | |
| example 1 | 2.2 | 0.09 | 49 | >100 | 36 |
| example 2 | 4.2 | 0.08 | 49 | >100 | 13 |
| example 3 | 7.5 | 0.09 | 46 | >100 | 7 |

Table 1 shows that the storage stability increases considerably while an acceptable swelling capacity is maintained if the initiator/monomer ratio is reduced below 0.07.

1-5. (canceled)

6. A method for production of storage stable polymer-oligomer particles with a high swelling capacity where polymer particles at first are added an initiator that is swelled into said particles and subsequently a monomer, or a mixture containing monomer, is added that is swelled into said particles, wherein the mole ratio between said initiator and said monomer is in the range from 0.07:1 to 0.01:1.

7. A method in accordance with claim 6, wherein the mole ratio between said initiator and said monomer is in the range from 0.06:1 to 0.03:1.

8. A method in accordance with claim 6, wherein said initiator is swelled into said polymer particles as a finely divided emulsion before monomer or a mixture containing monomer is added.

9. A method in accordance with claim 6, wherein said monomer is added by drops to said polymer particles.
